(19) United States
(12) Patent Application Publication
(10) Pub. No.: US 2017/0130588 A1
(43) Pub. Date: May 11, 2017

(54) SHROUDED TURBINE BLADE

(71) Applicant: ROLLS-ROYCE plc, London (GB)

(72) Inventor: Roderick M. TOWNES, Derby (GB)

(73) Assignee: ROLLS-ROYCE plc, London (GB)

(21) Appl. No.: 15/343,025

(22) Filed: Nov. 3, 2016

(30) Foreign Application Priority Data
Nov. 11, 2015 (GB) 1519869.0

(51) Int. Cl. F01D 5/14; F01D 5/18; F01D 25/32; F01D 11/08

(52) U.S. Cl. CPC F01D 5/147; F01D 11/08; F01D 5/18; F01D 25/32; F05D 2240/307; F05D 2240/55; F05D 2240/81; F05D 2260/20; F05D 2220/32; F05D 2240/11

(57) ABSTRACT

A shrouded turbine blade including a blade body having an operationally upstream face, an operationally downstream face, a root end and a tip end and a shroud segment provided at the tip end, the blade having an inlet in the root end and a cooling passage passing from the inlet to the tip end, the shroud segment comprising an arcuate platform and a seal fin arranged towards an operationally upstream end of the shroud platform and extending away from the blade body and circumferentially across the shroud platform, a fin cooling passage in fluid communication with the tip end of the blade cooling passage, the fin cooling passage having at least one outlet on an operationally downstream facing side of the fin, and a flow discourager arranged towards an operationally downstream end of the shroud platform.

### TECHNICAL FIELD

This invention relates to cooling of outer shrouds of shrouded rotor blades of a gas turbine engine. More particularly, the invention relates to a novel shroud geometry and a cooling arrangement for actively cooling the shroud.

### BACKGROUND TO THE INVENTION

In a gas turbine engine, ambient air is drawn into a compressor section. Alternate rows of stationary and rotating aerofoil blades are arranged around a common axis, together these accelerate and compress the incoming air. A rotating shaft drives the rotating blades. Compressed air is delivered to a combustor section where it is mixed with fuel and ignited. Ignition causes rapid expansion of the fuel/air mix which is directed in part to propel a body carrying the engine and in another part to drive rotation of a series of turbines arranged downstream of the combustor. The turbines share rotor shafts in common with the rotating blades of the compressor and work, through the shaft, to drive rotation of the compressor blades.

It is well known that the operating efficiency of a gas turbine engine is improved by increasing the operating temperature. The ability to optimise efficiency through increased temperatures is restricted by changes in behaviour of materials used in the engine components at elevated temperatures which, amongst other things, can impact upon the mechanical strength of the components. This problem is addressed by providing a flow of coolant through and/or over these components.

In a shrouded blade rotor, chordally extending shroud segments of adjacent blades meet along a circumference to form an annular shroud. The annular shroud serves to contain hot working gases within the blade row to optimise the output of the turbines. In addition, the shroud serves to protect components outside of the blade row from the excessive temperatures of the hot working gases. Typically one or more seal fins extends between an exposed surface of the shroud segment and a liner of the turbine section of the engine. The turbine is engineered to keep a gap between the fin tip and the liner to a minimum to prevent leakage of the hot working gases into this region. However, it is necessary to have a small clearance to account for differential thermal growth of the blade relative to the casing. Inadequate cooling of the seal fins can result in oxidation and consequent erosion/wear of the materials of the fin. This in turn broadens the gap, allowing increased leakage of hot gases and a consequent reduction in operational efficiency of the turbine section.

It is known to take off a portion of the air output from the compressor (which is not subjected to ignition in the combustor and so is relatively cooler) and feed this to surfaces in the turbine section which are likely to suffer damage from excessive heat. In the case of a turbine shroud, this air may be delivered passively, flowing over an exposed surface of the shroud, or actively by passing air through channels within the component. It will be appreciated coolant (including coolants other than air) may be supplied from an alternative coolant source.

In passive cooling of the shrouds of rotor blades, cooling air from the compressor is supplied axially to the shrouds via an annular gap between platforms of adjacent stator blades and the turbine casing (e.g. the liner). The cooling air primarily flows to the upper surface of the shrouds axially above the separation flow line of the working gas flow. Cooling air is delivered via a seal provided between the liner and shroud, while the thermally highly loaded bottom surface of the shroud is cooled only locally via conduction from the upper surface. Passive cooling of rotor blade shrouds can also be improved by substantially increasing the cooling air mass flow, however this requires taking off a greater portion of air from the compressor, leaving less for combustion and resulting in consequent aerodynamic losses.

Known active cooling arrangements comprise internal passages within the shroud which extend from fore to aft cooling the arcuate platform. Seal fins, however, are not actively cooled in such arrangements and are reliant on passive cooling. As a consequence, the fin can become impaired due to heat related wear, again resulting in enlargement of the gap and consequential aerodynamic losses.

In accordance with the present invention there is provided a shrouded turbine blade comprising a blade body having an operationally upstream face, an operationally downstream face, a root end and a tip end and a shroud segment provided at the tip end, the blade having an inlet in the root end and a cooling passage passing from the inlet to the tip end, the shroud segment comprising an chordally extending platform and a seal fin arranged towards an operationally upstream end of the shroud platform and extending away from the blade body and circumferentially across the shroud platform, a fin cooling passage in fluid communication with the tip end of the blade cooling passage, the fin cooling passage having at least one outlet on an operationally downstream facing side of the fin, and a flow discourager arranged towards an operationally downstream end of the shroud platform.

In some embodiments, the chordally extending platform is arcuate. In other embodiments, the chordally extending platform may be planar. Other possible platform surface geometries will no doubt occur to skilled addressee without departing from the scope of the invention as claimed.

Desirably, a row of outlets is provided in a circumferential direction across the seal fin, the fin cooling passage comprising an elongate passage extending in a circumferential direction across the arcuate platform of the shroud segment.

The configuration of the seal fin and flow discourager is such as to create pressure differentials which encourage flow from the outlet of the fin cooling passage to the discourager whilst discouraging back flow of hot gases from downstream of the flow discourager into a region between the flow discourager and seal fin. This can to some extent be controlled by the geometry of the seal fin and the discourager. Other factors such as the coolant pressure at the tip end of the blade cooling passage can also be controlled to assist in achieving this result. It will be well within the capabilities of the skilled addressee to determine configurations which achieve this goal without the need for further inventive thought.

When in situ in an operational turbine section of a gas turbine engine, a tip of the seal fin and a tip of the flow discourager may each define, with a liner of the turbine section, a gap. Preferably, the gap defined by the seal fin and the liner is narrower than the gap provided by the flow discourager and the liner.

The remainder of the shroud segment platform is optionally devoid of additional cooling channels. This enables a section of the platform extending between the seal fin and the flow discourager to be narrowed.

The flow discourager may take any of a number of forms. In one example, the flow discourager is a fin which extends circumferentially across the platform. Optionally the fin extends in parallel to the primary seal fin. In another option, the discourager fin extends obliquely across the platform. The discourager may have a straight profile or a curved profile.

In an alternative, the flow discourager may comprise at least one row of small vanes arranged to cross the platform in a circumferential direction. The vanes are optionally angled to the direction of flow of the coolant. The vanes may have any of a number of profiles, for example (without limitation), the vanes may be straight, arcuate, curved, chevrons or have an aerofoil shape.

Optionally, the shroud segment further comprises a dust hole (for example exiting through the arcuate platform) allowing the expulsion of dust from the blade cooling passage and/or the fin cooling passage.

### BRIEF DESCRIPTION OF THE FIGURES

Some embodiments of the invention will now be described by way of example and with reference to the accompanying figures in which;

FIG. 1 shows a prior known shrouded turbine blade arranged in a turbine section of a gas turbine engine;

FIG. 2 shows in more detail the blade of FIG. 1 and a cooling circuit of an active cooling system provided therein;

FIG. 3 shows the blade of FIG. 2 in combination with a prior known passive cooling arrangement in a gas turbine engine;

FIG. 4 shows a first embodiment of a shrouded blade in accordance with the invention;

FIG. 5 shows a second embodiment of a shrouded blade in accordance with the invention;

FIG. 6 shows a third embodiment of a shrouded blade in accordance with the invention;

FIG. 7 shows alternative configurations for a flow discourager for a shrouded blade in accordance with the invention;

FIG. 8 shows another embodiment of the invention;

FIG. 9 shows a gas turbine engine into which shrouded blades of the invention may be beneficially incorporated;

FIG. 10 shows a fourth embodiment of a shrouded blade in accordance with the invention.

### DETAILED DESCRIPTION OF DRAWINGS AND EMBODIMENTS

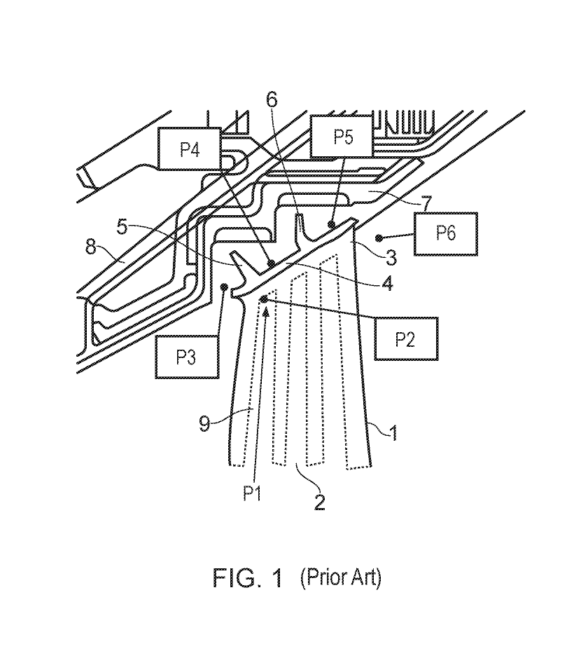

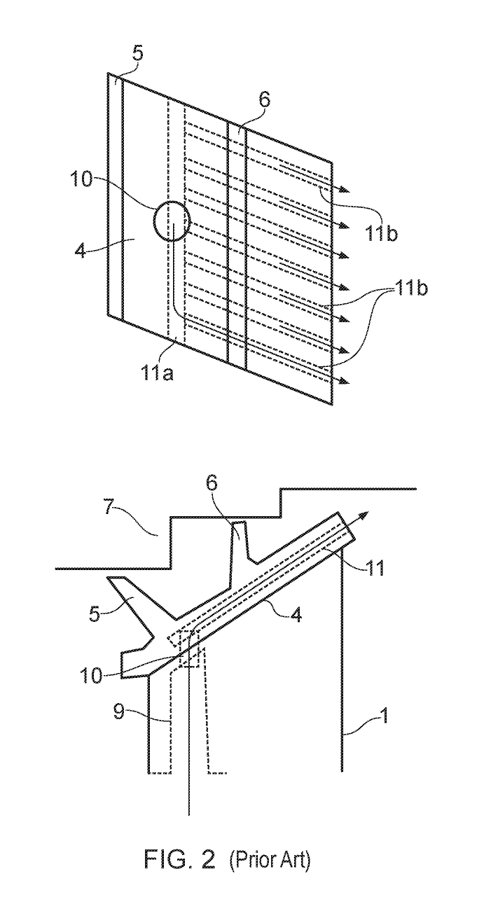

FIG. 1 shows a cross section through a prior known shrouded turbine blade. The blade comprises a blade body 1 having a root end 2 and a tip end 3. The tip end 3 is provided with an arcuate shroud segment which comprises a shroud platform 4, a first seal fin 5 towards an upstream facing end of the platform 4 and a second seal fin 6 towards a downstream facing end of the platform 4. The seal fins 5 and 6 sit within stepped portions of a liner 7 which lines turbine casing 8. The seal fins 5, 6 discourage the leakage of hot working gases through the space between the liner 7 and shroud 4, 5, 6. In an operational engine, a source of coolant air is delivered through an inlet in the root of the blade 2 along a coolant passage 9 to the shroud platform 4. Where it is distributed via a network of interconnected cooling passages (see FIG. 2).

FIG. 1 further shows the blade coolant feed pressure source P1, and different pressure zones at the tip P2, P3, P4, P5 and P6 which can be identified in the region of the shroud.

The seal fins 5, 6 are ran as tightly as possible to minimise the gap between their tips and the liner 7 and hence minimise leakage of the working gases. The arrangement results in progressively decreasing external pressures from zone P3 towards zone P6. It has been recognised by the inventors that in some cases it can be advantageous to engine operating efficiency for the turbine blade to have a low pressure feed system. In this situation, the pressure differentials in this arrangement are such that the available internal coolant pressure P2 entering the shroud platform 4 from the passage 9 is insufficient to deliver cooling flow upstream of the first seal fin 1 and into zone P3, or between the first 5 and second 6 seal fins into zone P4. Downstream of second seal 6, the external pressure P5 drops low enough to enable cooling flow to this zone which is close in pressure to the pressure P6 in the main workflow passage immediately downstream of the blade. As previously discussed, an increased coolant pressure P2 (giving rise to positive pressure gradient between zone P2 and the zones P3 and P4) could enable the delivery of coolant to other regions of the shroud 4,5,6 and the space between the shroud and liner 7, however this would be at the expense of reducing the flow to the combustor and a consequential reduction in operating efficiency of the engine.

FIG. 2 shows a known arrangement of coolant passages in a shroud of a shrouded blade such as that shown in FIG. 1. As can be seen, blade cooling passage 9 is delivered to inlet 10 of the shroud platform. The inlet 10 is in turn in fluid communication with a network of passages 11 made up of a circumferentially extending channel 11a which is met by a plurality of upstream to downstream extending passages 11b. The flow path of coolant from the blade passage 9 through the shroud platform 4 is shown by the arrows. Whilst the arrangement adequately cools the shroud platform 4 downstream of the first seal fin 5, it will be appreciated that the seal fins 5, 6 experience no direct cooling. As a consequence of the lack of local cooling in these areas, the seal fins 5 and 6 are prone to approach the temperature of the hot working gas. When exposed to the elevated temperature over time, the fins will oxidise away thereby increasing the clearance gap between the seal tips and the liner 7 resulting in increased leakage of hot working gas and a consequent deterioration in engine performance (higher fuel burn).

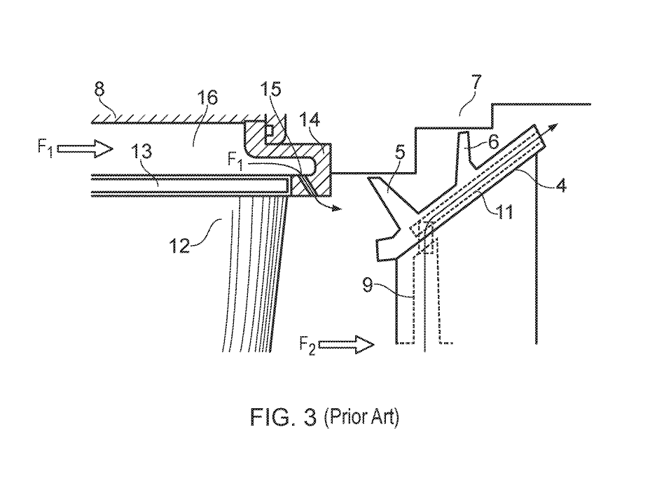

As previously discussed, coolant to the first seal fin 5 and pressure zone P3 can be improved by passive cooling. FIG. 3 shows a prior known passive cooling arrangement. As can be seen the shrouded blade of FIG. 2 is arranged in an engine upstream of a vane 12 of a stator. The vane 12 has a radially outer platform which is radially spaced from turbine casing 8 by gap 16. The flow path of cooling air bled from the compressor section of the engine (not shown) is broadly represented by arrows F₁. Hot working gas flows through the engine along a flow path broadly represented by arrow F₂. A seal 14 bridges the casing 8 and stator vane platform 13 and has a flow passage 15 which directs coolant delivered to the gap 16 towards the upstream facing side of first seal fin 5. Thus the seal fin 5 benefits from some indirect cooling flow but there remains insignificant cooling of adjacent Zone 4.

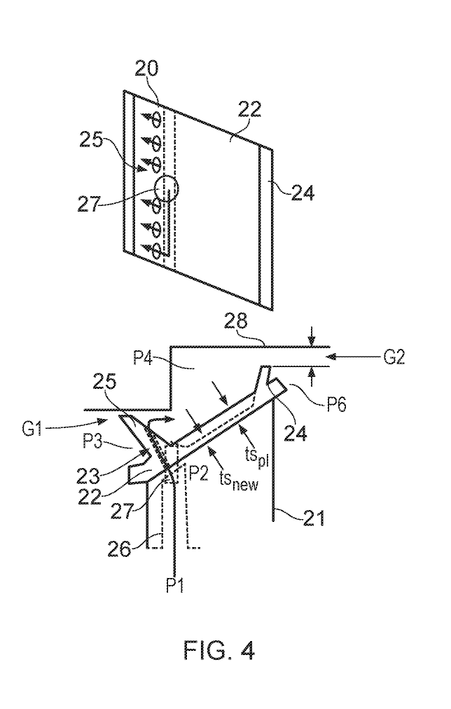

FIG. 4 shows a first embodiment of a shrouded blade in accordance with the invention. Differences to prior known shrouded blade designs are confined to the shroud segment which is now described in more detail. As can be seen the blade comprises a body 21 on the tip of which is provided a shroud segment 22. The shroud segment has a primary seal fin 23 arranged towards an operationally upstream end of the shroud segment 22 and extending away from the blade body 21 and circumferentially across the segment 22. A first clearance gap of dimension G1 separates the tip of the primary seal fin 23 from the liner 28. The gap G1 is engineered to be minimal to accommodate radial expansion of the blade but at the same time block leakage flow across the gap G1.

In common with the prior art, the blade body 21 has a blade cooling passage 26 which is fed through an inlet in the root of the blade body 21. Coolant exiting the passage 26 passes to inlet 27 in the shroud segment 22 which sits at the root of the primary seal fin 25 and is in turn in fluid communication with a row of outlet holes 20 provided in a downstream facing side of the primary seal fin 25. Coolant exiting the outlet holes 20 is directed downstream of the primary seal fin 25 across the exposed surface of the arcuate platform 22 of the shroud segment. Towards a downstream end of the platform 22 is provided a secondary flow discourager 24 which may take anyone of a number of forms, some of which are described in more detail below. By comparison to the prior art, the discourager 24 sits closer to the downstream end extending pressure zone P4 and substantially eliminating pressure zone P5 of the prior art.

The discourager 24 is configured and arranged to provide a second clearance gap G2, larger than first clearance gap G1, between the tip of the discourager 24 and the liner 7. The size of second clearance gap (G2) is selected to achieve a pressure in zone P4 which encourages flow of coolant from outlet holes 20 across the shroud segment 22 towards the downstream. The gap G2 is also selected to maintain a pressure differential between pressure zones P4 and P6 which discourages backflow of hot working gas in zone P6 into zone P4.

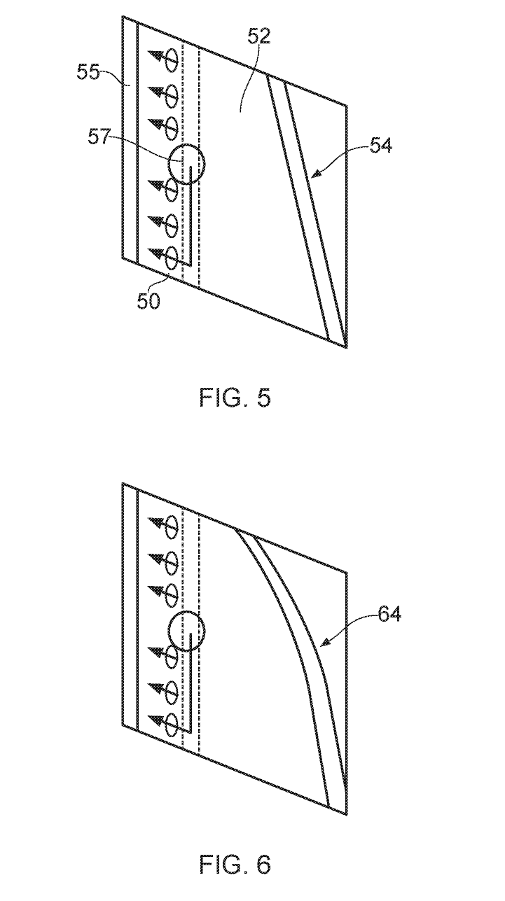

FIG. 5 shows an alternative embodiment to FIG. 4. The cooling arrangement of shroud segment 52 includes an inlet 57 which sits at the root of the primary seal fin 55 and is in turn in fluid communication with a row of outlet holes 50 provided in a downstream facing side of the primary seal fin 55. Coolant exiting the outlet holes 50 is directed downstream of the primary seal fin 55 across the exposed surface of the shroud segment 52. Towards a downstream end of the shroud segment 52 is provided a secondary flow discourager 54. In this embodiment, the flow discourager 54 comprises a fin which extends obliquely from adjacent a downstream corner of the segment 52 on a first side of the shroud segment 52 to a more upstream position on an opposite side of the shroud segment 52. As discussed in relation to FIG. 4, this second fin 54 is sized to provide a greater gap between the tip of this fin and a liner of the turbine section of an engine compared to the gap provided by the primary seal fin 55.

FIG. 6 shows another alternative embodiment. The embodiment differs from that of FIG. 5 only by the form of the flow discourager 64. Whereas the flow discourager (seal fin) 54 of FIG. 5 extends in a straight line, the flow discourager 64 of this embodiment curves as it crosses the shroud segment platform.

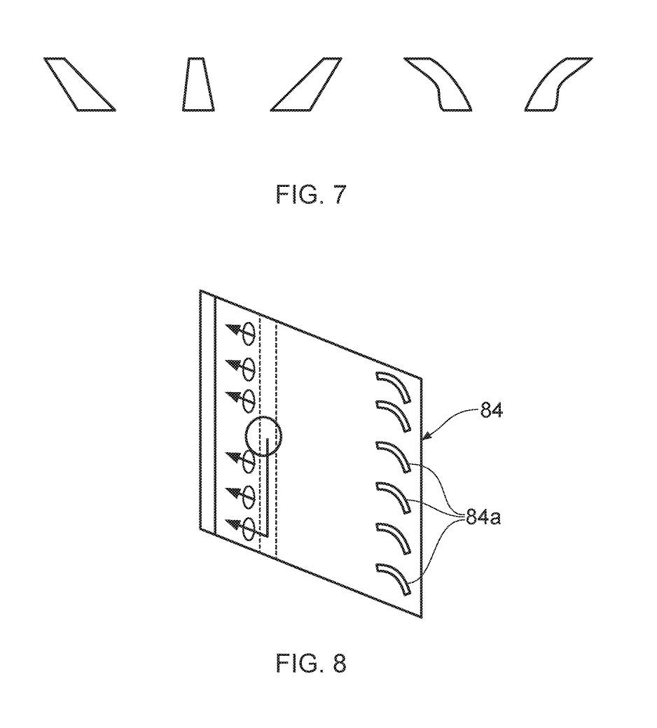

FIG. 7 illustrates further examples of flow discouragers in the form of shaped seal fins which could be substituted for the flow discourages 54, 64 of the embodiments of FIGS. 5 and 6.

FIG. 8 illustrates another embodiment of the invention. The embodiment differs from that of FIGS. 5 and 6 only by the form of the flow discourager 84. In this arrangement the flow discourager is provided in the form of a row of mini vanes 84a extending across a downstream end of the shroud segment platform. In this embodiment the vanes are shown as arcuate in cross section, though other vane shapes could be substituted. For example (but without limitation), the vanes may be straight, may have an aerofoil cross section or may be chevron shaped. The vanes desirably present a wall which is angled with respect to the main direction of flow of coolant from the primary seal fin.

Advantages of this novel shroud sealing and cooling arrangement include;
The primary seal fin can be actively cooled to a desired level without necessitating an increased pressure in the coolant feed to the blade body.
The arrangement avoids the need for the more inefficient passive cooling arrangement of the prior art.
Effective cooling of the primary sealing fin advantageously reduces thermal erosion of the fin and maintains a better seal for longer, hence greater turbine efficiency can be maintained for longer.
By increasing the temperature capability of the blade shroud, higher row inlet temperatures can be accommodated in the turbine increasing the thermal efficiency of the engine.
A network of active cooling passages within the segment shroud platform can optionally be dispensed with allowing the depth tsₚ₁ of the platform to be reduced ts_{new} by comparison to the prior art. Such a reduction could reduce the overall weight of the blade beneficially reducing centrifugal force on the blade and disc allowing for further weight reduction in these components and a consequent achievable increase in engine efficiency.
The reduction of pressure in the zone P4 permits the adding of a dust hole from the blade cooling passages, reducing the risk of dirt blockage therein.

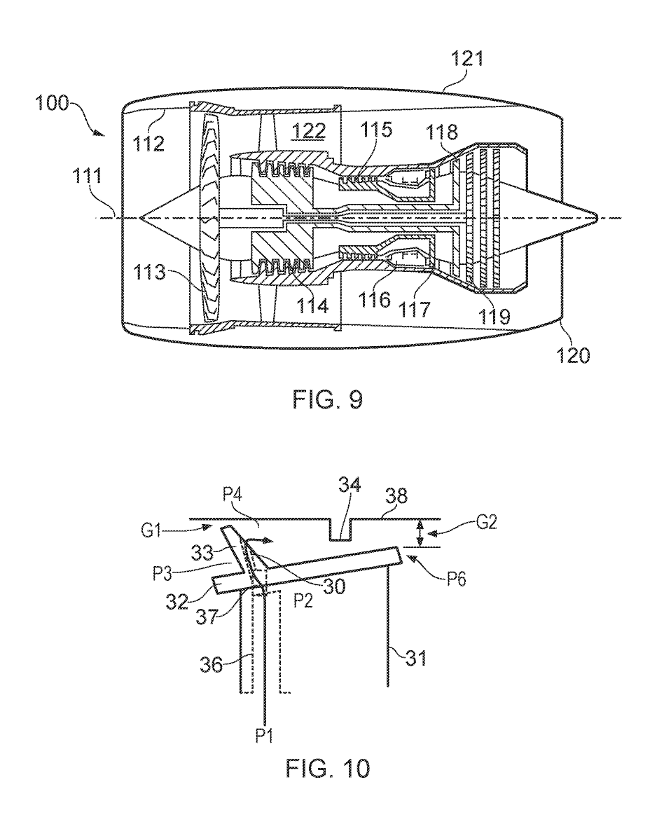

With reference to FIG. 9, a gas turbine engine is generally indicated at 100, having a principal and rotational axis 111. The engine 100 comprises, in axial flow series, an air intake 112, a propulsive fan 113, an intermediate pressure compressor 114, a high-pressure compressor 115, combustion equipment 116, a high-pressure turbine 117, an intermediate pressure turbine 118, a low-pressure turbine 119 and an exhaust nozzle 120. A nacelle 121 generally surrounds the engine 100 and defines both the intake 112 and the exhaust nozzle 120.

The gas turbine engine 100 works in the conventional manner so that air entering the intake 112 is accelerated by the fan 113 to produce two air flows: a first air flow into the intermediate pressure compressor 114 and a second air flow which passes through a bypass duct 122 to provide propulsive thrust. The intermediate pressure compressor 114 compresses the air flow directed into it before delivering that air to the high pressure compressor 115 where further compression takes place.

The compressed air exhausted from the high-pressure compressor 115 is directed into the combustion equipment 116 where it is mixed with fuel and the mixture combusted. The resultant hot combustion products then expand through, and thereby drive the high, intermediate and low-pressure turbines 117, 118, 119 before being exhausted through the nozzle 120 to provide additional propulsive thrust. The high 117, intermediate 118 and low 119 pressure turbines drive respectively the high pressure compressor 115, intermediate pressure compressor 114 and fan 113, each by suitable interconnecting shaft.

Any one or more of high-pressure turbine 117, intermediate pressure turbine 118, and low-pressure turbine 119 could beneficially comprise shrouded blades in accordance with the present invention.

Other gas turbine engines to which the present disclosure may be applied may have alternative configurations. By way of example such engines may have an alternative number of interconnecting shafts (e.g. two) and/or an alternative number of compressors and/or turbines. Further the engine may comprise a gearbox provided in the drive train from a turbine to a compressor and/or fan.

FIG. 10 shows another embodiment of a shrouded blade in accordance with the invention. Differences to prior known shrouded blade designs are confined to the region of the shroud segment and are now described in more detail. As can be seen the blade comprises a body 31 on the tip of which is provided a shroud segment 32. The shroud segment has a primary seal fin 33 arranged towards an operationally upstream end of the shroud segment 32 and extending away from the blade body 31 and circumferentially across the segment 32. A first clearance gap of dimension G1 separates the tip of the primary seal fin 33 from the liner 38. The gap G1 is engineered to be minimal to accommodate radial expansion of the blade but at the same time block leakage flow across the gap G1.

In common with the prior art, the blade body 31 has a blade cooling passage 36 which is fed through an inlet in the root of the blade body 31. Coolant exiting the passage 36 passes to inlet 37 in the shroud segment 32 which sits at the root of the primary seal fin 33 and is in turn in fluid communication with a row of outlet holes 30 provided in a downstream facing side of the primary seal fin 33. Coolant exiting the outlet holes is directed downstream of the primary seal fin 25 across the exposed surface of the arcuate platform 22 of the shroud segment. Towards a downstream end, on a surface of the line 38 and extending towards platform 32 is provided a secondary flow discourager 34 which may take any one of a number of forms already described above. By comparison to the prior art, the discourager 34 sits closer to the downstream end extending pressure zone P4 and substantially eliminating pressure zone P5 of the prior art.

The discourager 34 is configured and arranged to provide a second clearance gap G2, larger than first clearance gap G1, between the tip of the discourager 34 and the liner 37. The size of second clearance gap (G2) is selected to achieve a pressure in zone P4 which encourages flow of coolant from outlet holes 30 across the shroud segment 32 towards the downstream. The gap G2 is also selected to maintain a pressure differential between pressure zones P4 and P6 which discourages backflow of hot working gas in zone P6 into zone P4.

It will be understood that the invention is not limited to the embodiments above-described and various modifications and improvements can be made without departing from the concepts described herein. Except where mutually exclusive, any of the features may be employed separately or in combination with any other features and the disclosure extends to and includes all combinations and sub-combinations of one or more features described herein.

1. A shrouded turbine blade comprising a blade body having an operationally upstream face, an operationally downstream face, a root end and a tip end and a shroud segment provided at the tip end, the blade having an inlet in the root end and a cooling passage passing from the inlet to the tip end, the shroud segment comprising a chordally extending platform and a seal fin arranged towards an operationally upstream end of the shroud platform and extending away from the blade body and circumferentially (with respect to the circumference of a disc in which the blade is to be mounted) across the shroud platform, a fin cooling passage in fluid communication with the tip end of the blade cooling passage, the fin cooling passage having at least one outlet on an operationally downstream facing side of the fin, and a flow discourager arranged towards an operationally downstream end of the shroud platform.

2. The shrouded turbine blade as claimed in claim 1 wherein a row of outlets is provided in a circumferential direction (with respect to the circumference of a disc in which the blade is to be mounted) across the seal fin, the fin cooling passage comprising an elongate passage extending in a circumferential direction (with respect to the circumference of a disc in which the blade is to be mounted) across the shroud platform.

3. The shrouded turbine blade as claimed in claim 1 wherein the configuration of the seal fin and flow discourager is such as to create pressure differentials which encourage flow from the outlet of the fin cooling passage to the discourager whilst discouraging back flow of hot gases from downstream of the flow discourager into a region between the flow discourager and seal fin.

4. The shrouded turbine blade as claimed in claim 3 wherein, when in situ in an operational turbine section of a gas turbine engine, a tip of the seal fin and a tip of the flow discourager each defines, with a liner of the turbine section, a gap and the gap defined by the seal fin and the liner is narrower than the gap provided by the flow discourager and the liner.

5. The shrouded turbine blade as claimed in claim 1 wherein the remainder of the shroud segment platform is devoid of additional cooling channels.

6. The shrouded turbine blade as claimed in claim 5 wherein a section of the platform extending between the seal fin and the flow discourager is narrowed.

7. The shrouded turbine blade as claimed in claim 1 wherein the flow discourager comprises a fin which extends circumferentially (with respect to the circumference of a disc in which the blade is to be mounted) across the platform.

8. The shrouded turbine blade as claimed in claim 7 wherein the discourager fin extends in parallel to the seal fin.

9. The shrouded turbine blade as claimed in claim 7 wherein the discourager fin has a straight profile.

10. The shrouded turbine blade as claimed in claim 7 wherein the discourager fin has a curved profile.

11. The shrouded turbine blade as claimed in claim 1 wherein the flow discourager comprises at least one row of small vanes arranged to cross the shroud platform in a circumferential direction (with respect to the circumference of a disc in which the blade is to be mounted).

12. The shrouded turbine blade as claimed in claim 11 wherein the vanes are angled to the direction of flow of the coolant.

13. The shrouded turbine blade as claimed in claim 10 wherein the vanes have a profile selected from; straight, arcuate, curved, chevrons or have an aerofoil shape.

14. The shrouded turbine blade as claimed in claim 13 wherein the shroud segment platform further comprises a dust hole configured to allow the expulsion of dust from the blade cooling passage and/or the fin cooling passage.

15. The shrouded turbine blade as claimed in claim 1 wherein when the turbine blade is in situ in an engine radially adjacent a liner, the discourager is provided on a radially opposite surface of the liner and extends towards the shroud platform surface.

16. A turbine rotor for a gas turbine engine comprising a row of shrouded turbine blades, each turbine blade having a configuration as set forth in claim 1.

17. A gas turbine engine comprising one or more turbine rotors, the turbine rotors having the configuration set forth in claim 16.
